(19) United States
(12) Patent Application Publication
(10) Pub. No.: US 2009/0046953 A1
(43) Pub. Date: Feb. 19, 2009

(54) Image Processing Apparatus And Method

(75) Inventors: Adrianus Josephus Bink, Eindhoven (NL); Richard Petrus Kleihorst, Kasterlee (BE); Marcus Josephus Maria Heijligers, Geldrop (NL); Anteneh Alemu Abbo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N V, Eindhoven (NL)

(21) Appl. No.: 11/568,403

(22) PCT Filed: Apr. 26, 2005
(86) PCT No.: PCT/IB2005/051364

§ 371 Date: May 8, 2008

(30) Foreign Application Priority Data
Apr. 29, 2004 (EP) 04101832.6

(51) Int. Cl. G06K 9/60

(52) U.S. Cl. 382/307

(57) ABSTRACT

An image processing apparatus (400) comprises a SIMD processor (401) which scans an image frame for regions of interest (step 301), for example corresponding to regions having objects or lines of interest. Each region of interest is rescanned to an orthogonal grid. The orthogonal grids are then floorplanned so that they are rearranged into a smaller subset of image lines. The floorplanning consists of mapping a set of rectangles into a compressed frame portion. Optionally, the rectangles can be rotated in order to allow the rectangles to be packed more densely. The SIMD processor (401) then processes the floorplanned image data (step 307). Once the image data has been processed by the SIMD processor, the DSP (405) re-associates the processed data (step 309), using information stored during floorplanning. The image processing apparatus results in a more efficient use of the SIMD processor (401).

The invention relates to an image processing apparatus and method, and in particular, to an image processing apparatus using Single Instruction Multiple Data (SIMD), in which floorplanning of SIMD tasks is employed to provide more efficient SIMD processing.

SIMD processing is a powerful computing paradigm for applications that exhibit massive parallelism. One such application that adopts the use of SIMD processing is that of image processing. SIMD processors, for example Xetal, perform their operations on each data item (e.g. each pixel in a line for Xetal) whether they are needed or not. In other words, a processing operation is performed on a pixel in a line regardless of whether or not a processing operation is required. Depending on the data distribution or sparsity, much computation power can therefore be wasted using this technique.

More and more image processing algorithms are being developed to work on portions of images. For example, in television processing, industrial vision or medical imaging, it is known to work on the edges of images (i.e. line processing). Also, in applications such as image communication or 3 D rendering, it is known to work on separate objects within an image (i.e. object processing), thereby reducing the amount of unnecessary processing operations.

Several solutions exist for making efficient use of SIMD computing resources. For example, one method is to load-balance over multiple SIMD processors. Another is to provide algorithms that use special data structures to operate efficiently on sparse structures. For example, such a technique is disclosed in “Massive parallelism for sparse images”, Shankar et al, IEEE International Conference on Decision Aiding for Complex Systems, 1991. However, such systems suffer from the disadvantage that they require control and hardware overheads.

The methods described above also suffer from the disadvantage of processing data items which are of no interest.

The aim of the present invention is to provide an improved image processing apparatus and method which does not suffer from the disadvantages mentioned above, and in which the number of unnecessary data operations is reduced.

According to a first aspect of the present invention, there is provided an image processing apparatus comprising a processing means adapted to receive an image signal and identify regions of interest within an image frame. A rescanning means is adapted to rescan each region of interest into an orthogonal grid. The rescanned regions are then rearranged by rearranging means into a compressed frame portion, such that the processing apparatus processes the rearranged regions of the compressed frame portion.

The invention has the advantage of only processing the compressed frame portion, thereby making more efficient use of the processing apparatus.

According to another aspect of the present invention, there is provided a method of processing an image signal using a SIMD processor. The method comprises the steps of identifying regions of interest in an image frame, and rescanning each region of interest into an orthogonal grid. The rescanned regions are then rearranged into a compressed frame portion, such that only the compressed frame portion is processed by the SIMD processor.

For a better understanding of the present invention, and to show more clearly how it may be carried into effect, reference will now be made, by way of example, to the accompanying drawings, in which:

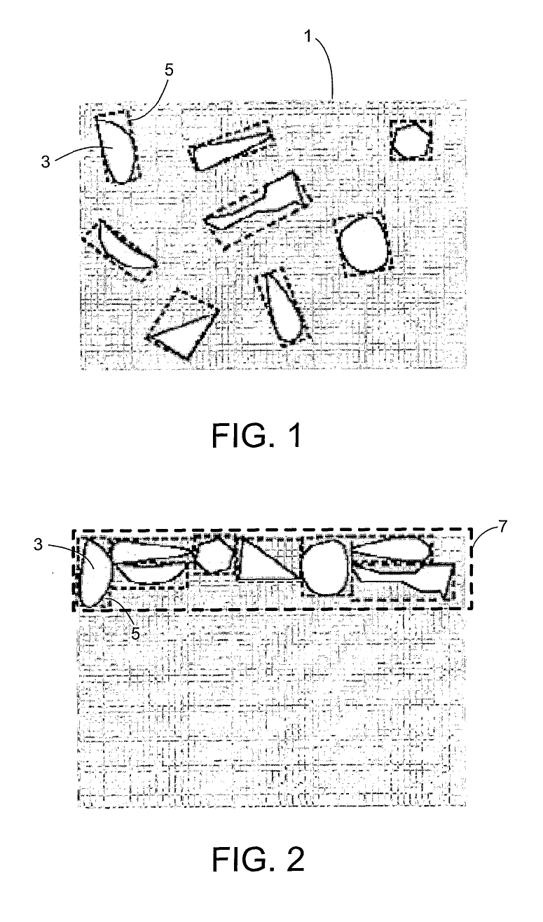

FIG. 1 shows an image having objects sparsely distributed within an image frame;

FIG. 2 shows the result of floorplanning the objects of FIG. 1 prior to processing, in accordance with the present invention;

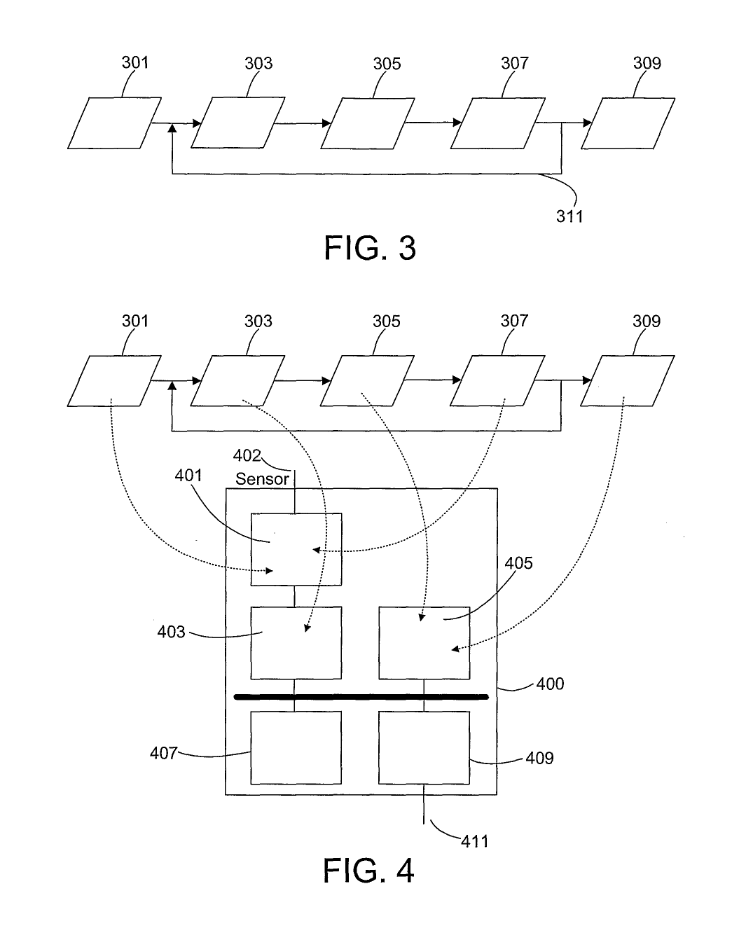

FIG. 3 shows the steps involved in the floorplanning operation;

FIG. 4 shows the mapping of tasks to a vision architecture; and

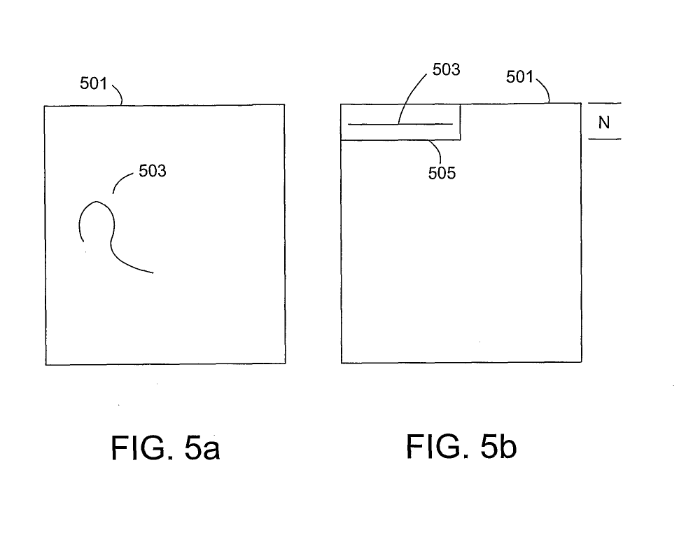

FIGS. 5a and 5b show how a line or edge may be reshaped prior to processing.

FIG. 1 shows an image frame 1 comprising a plurality of objects 3. A SIMD processor working on the image frame 1 identifies the regions of interest within the image frame 1. The regions of interest correspond, for example, to the regions where the objects 3 are located.

After identifying a region of interest, for example by the SIMD processor, the region of interest is rescanned to an orthogonal grid 5, for example using the techniques described in co-pending patent application ID612814. The rescanning process involves rescanning regions of an image to line or rectangle based regions on which a SIMD processor can efficiently perform its line or rectangle based processing. Preferably, the rescanning of the region of interest onto an orthogonal grid is done to place a line or an edge onto a column or row. However, it is not essential that this is done exactly on a row or column, since this would be impracticable.

Since a region of interest having an object 3 is rescanned to an orthogonal grid 5, the amount of further processing required by the SIMD processor is reduced, and is limited to the lines that fall together on the shortest dimension of the orthogonal grid 5.

Although the arrangement shown in FIG. 1 might slightly reduce the number of computational operations performed by the SIMD processor, it still performs a number of unnecessary operations on all image parts where there are no objects.

FIG. 2 shows the image processing operations performed in accordance with the invention. As described in FIG. 1, a pre-processing operation is performed to identify the regions of interest where the objects 3 are located. Each region of interest is then rescanned to an orthogonal grid 5. However, prior to processing the image data, the orthogonal grids 5 corresponding to the regions of interest are floorplanned into a compressed frame portion 7.

This means that the further processing only has to be performed on a subset of the lines in the image frame, corresponding to the compressed frame portion 7. Additionally, since the subset of lines in the compressed frame portion 7 are packed more densely with regions of interest, more efficient use of the SIMD processor is achieved.

FIG. 3 describes in greater detail the steps performed according to the image processing method of the present invention. In step 301, the regions of interest are identified within an image frame. The regions of interest correspond, for example, to regions having objects 3 of interest. In step 303, each region of interest is rescanned to an orthogonal grid.

Then, in step 305, the orthogonal grids are floorplanned so that they are rearranged into a smaller subset of image lines, corresponding to a compressed frame portion. The floorplanning step 305 consists of mapping a set of rectangles, i.e. orthogonal grids 5, into a compressed frame portion 7. Optionally, the rectangles can be rotated in order to allow the orthogonal grids to be packed more densely into the compressed frame portion 7. Preferably, the floorplanning step is performed using a general purpose processor that is used to assist the SIMD processor. In contrast with conventional floorplanning algorithms used for other purposes, the floorplanning operation performed by the present invention stores information relating to the movement (and possibly information relating to the rotation of) the original rectangles, for later use as described below.

The SIMD processor then processes the floorplanned image data, step 307. Since the SIMD processor performs a similar instruction for all pixels in a row, the floorplanned image data is processed more efficiently. This is because more objects are packed on a row, which means that more pixels are usefully processed. Once the image data has been processed by the SIMD processor, the results are re-associated in step 309 to their original frame positions, using the stored information mentioned above. This involves re-associating the computed data with the regions of the image prior to the floorplanning operation.

Optionally, the rescanning, floorplanning and SIMD processing steps 303, 305, 307 can be re-iterated if needed (step 311) until the desired level of processing has been reached.

FIG. 4 shows a preferred embodiment describing how the steps performed in FIG. 3 are realized in the image processing apparatus. The image processing apparatus 400 comprises a memory 407 and a display processor 409 for providing image data 411 to a display device (not shown). The image processing apparatus 400 comprises a SIMD processor 401 which receives input image data 402 from a sensor (not shown). The SIMD processor 401 is used to identify the regions of interest within a received image signal (i.e. corresponding to step 301). Data from the SIMD processor is processed by an FPGA 403, which rescans the image data to an orthogonal grid, corresponding to step 303. As mentioned above, the floorplanning operation, step 305, is preferably performed by a general purpose processor, for example a TriMedia DSP 405. The floorplanned image data is then processed by the SIMD processor 401, with the re-association or re-mapping (step 309) being performed by the TriMedia DSP 405.

The invention described above provides an image processing apparatus and method in which more efficient use of SIMD processing is provided.

It will be appreciated that the invention is not limited to the specific architecture described in the preferred embodiment, and other hardware architectures could be used to provide similar functions to those described above.

In addition, although the preferred embodiment relates to identifying objects of interest in the image, the invention can equally be applied to lines or edges of interest, which are rescanned to an orthogonal grid. For example, FIG. 5a shows an image frame 501 having an edge 503. According to the invention, the edge 503 may be reshaped such that the edge lies within a reduced set of lines “N”, as shown in FIG. 5b. The reshaping information is stored, such that the image data processed by the SIMD processor can be re-transformed to its original shape after processing.

The invention can be applied to a number of different applications, including: the processing of television images to increase the image quality; performing object recognition in computer vision applications; performing image rendering for computer gaming, education or CAD/CAM; performing object based coding for MPEG4, H263+; performing image processing for medical systems.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a claim enumerating several means, several of these means may be embodied by one and the same item of hardware. The mere fact that certain measures are recited in mutually different dependent claims does not indicate that a combination of these measures cannot be used to advantage.

1. A method of processing an image signal using a SIMD processor, the method comprising the steps of:
identifying regions of interest in an image frame;
rescanning each region of interest into an orthogonal grid;
rearranging the rescanned regions into a compressed frame portion; and
processing the compressed frame portion in the SIMD processor.

2. A method as claimed in claim 1, wherein the step of rearranging comprises the step of floorplanning the regions of interest into the compressed frame portion.

3. A method as claimed in claim 1, wherein the step of rearranging further comprises the step of rotating one or more regions of interest, thereby enabling the area of the compressed frame portion to be reduced.

4. A method as claimed in claim 1, wherein the step of rearranging further comprises the step of storing information relating to the original position of the region in the image frame.

5. A method as claimed in claim 3, wherein the rearranging step further comprises the step of storing information relating to the rotation of the region.

6. A method as claimed in claim 4, further comprising the step of re-mapping the regions after the processing step using the stored information.

7. A method as claimed in claim 1, wherein a region of interest is one of a rectangle, line or object.

8. A method as claimed in claim 1, wherein the step of rearranging is performed by a processor that is separate from the SIMD processor.

9. A method as claimed in claim 1, wherein the rescanning, rearranging and processing steps are reiterated.

10. A method as claimed in claim 1, wherein the rescanning step further comprises the step of reshaping a line or edge in the image signal.

11. An image processing apparatus comprising:
processing means adapted to receive an image signal and identify regions of interest within an image frame;
rescanning means adapted to rescan each region of interest into an orthogonal grid;
rearranging means adapted to rearrange the rescanned regions into a compressed frame portion; and
processing means for processing the rearranged regions of the compressed frame portion.

12. An image processing apparatus as claimed in claim 11, wherein the rearranging means comprises floorplanning means for rearranging the regions of interest into the compressed frame portion.

13. An image processing apparatus as claimed in claim 11, wherein the rearranging means is adapted to rotate one or more regions of interest, thereby enabling the area of the compressed frame portion to be reduced.

14. An image processing apparatus as claimed in claim 11, wherein the rearranging means is adapted to store information relating to the original position of the region in the image frame.

15. An image processing apparatus as claimed in claim 14, wherein the rearranging means is adapted to store information relating to the rotation of the region.

16. An image processing apparatus as claimed in claim 14, further comprising means for re-mapping the regions after processing by the processing means, using the stored information.

17. An image processing apparatus claimed in claim 11, wherein a region of interest includes a rectangle or line.

18. An image processing apparatus as claimed in claim 11, wherein the rearranging means comprises a processor that is separate from the SIMD processor.

19. An image processing apparatus as claimed in claim 11, wherein the rescanning means, rearranging means and processing means are adapted to perform an iteration process.

20. An image processing apparatus as claimed in claim 11, wherein the rescanning means is further adapted to reshape a line or edge in the image signal.
